(19) United States
(12) Patent Application Publication
(10) Pub. No.: US 2020/0399475 A1
(43) Pub. Date: Dec. 24, 2020

(54) COLOR PHOTORESIST COMPOSITION

(71) Applicant: TCL China Star Optoelectronics Technology Co., Ltd., Shenzhen, Guangdong (CN)

(72) Inventor: Yuehong ZHANG, Shenzhen, Guangdong (CN)

(21) Appl. No.: 16/616,478

(22) PCT Filed: Nov. 14, 2019
(86) PCT No.: PCT/CN2019/118390

§ 371 Date: Nov. 24, 2019

(30) Foreign Application Priority Data
Jun. 24, 2019 (CN) 201910548686.0

(51) Int. Cl. C09B 47/08; C08K 5/3417

(52) U.S. Cl. CPC C09B 47/08; G02B 5/223; C08K 5/3417

(57) ABSTRACT

The present invention provides a color photoresist composition, based on 100 parts by weight of the color photoresist composition, including: 5-10 parts by weight of a pigment dispersion; 5-8 parts by weight of a binder resin; 5-8 parts by weight of a sandwich type phthalocyanine compound dye; 0.3-0.8 parts by weight of a photoinitiator; 70-85 parts by weight of a photoresist solvent; and 0.1-0.2 parts by weight of an additive.

### BACKGROUND OF INVENTION

### Field of Invention

The present invention relates to a color photoresist composition, and more particularly to a color photoresist composition that alleviates light scattering in a photoresist.

### Description of Prior Art

A color filter (CF) is an important component for color display of a liquid crystal display. A color photoresist is an important composition of color filter and can be divided into three types: red (R), green (G), and blue (B). A current color filter photoresist generally achieves their hue by adding pigments of different colors, wherein the pigments are insoluble materials and introduced into a substrate in a highly dispersed state. Dispersed pigment particles may severely scatter light, which in turn reduces transmittance and contrast of the CF.

In order to improve transmittance and contrast of a color filter, there is an urgent need for a novel color photoresist composition, which can effectively alleviate light scattering in a photoresist, thereby improving transmittance and contrast of the color filter.

### SUMMARY OF INVENTION

In view of the above, the present invention provides a color photoresist composition in which a semi-sandwich type phthalocyanine compound is introduced as a dye, which can effectively alleviate light scattering caused by pigment particles in a photoresist due to its high thermal stability and high solubility, thereby improving transmittance and contrast of a color filter.

Accordingly, in accordance with an embodiment of the present invention, the present invention provides a color photoresist composition, based on 100 parts by weight of the color photoresist composition, including: 5-10 parts by weight of a pigment dispersion; 5-8 parts by weight of a binder resin; 5-8 parts by weight of a sandwich type phthalocyanine compound dye; 0.3-0.8 parts by weight of a photoinitiator; 70-85 parts by weight of a photoresist solvent; and 0.1-0.2 parts by weight of an additive.

In an embodiment of the present invention, the sandwich type phthalocyanine compound dye includes a sandwich type phthalocyanine compound and a dye solvent, and the sandwich type phthalocyanine compound has a structure of Formula 1:

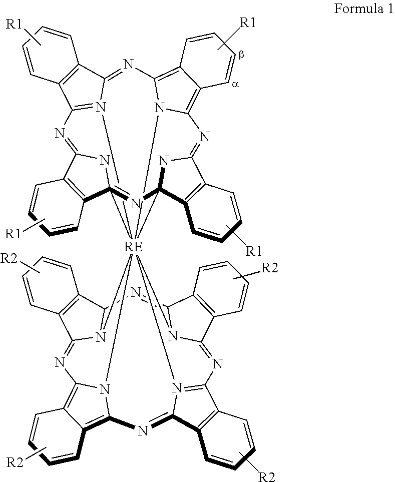

in the Formula 1, a central coordination metal RE is a rare earth metal element;

R1 and R2 are each independently selected from at least one of H, a substituted or unsubstituted C1 to C20 aliphatic carbon chain, a C1 to C20 oxycarbon chain, an aromatic ring, a halogen, a carboxyl group, an ester group, an amino group, and —SH; and

each of substitution positions of R1 and R2 is independently selected from at least one of α and β.

In an embodiment of the present invention, the rare earth metal element includes: lanthanum (La), cerium (Ce), praseodymium (Pr), cerium (Nd), cerium (Pm), cerium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), or scandium (Sc).

In an embodiment of the present invention, each of R1 and R2 is independently selected from at least one of H, —C₅H₁₂, —C₆H₁₄, —OC₄H₁₀, —OC₅H₁₂, —OC₆H₁₄, —OC₈H₁₈, a substituted or unsubstituted benzene ring, a substituted or unsubstituted naphthalene ring, a substituted or unsubstituted phenoxy, —F, —Cl, —Br, —I, —COOCH₃, —COOCH₂CH₃, —COOCH₂CH₂CH₃, —NH₂, —N(CH₃)₂, —N(CH₂CH₃)₂, —N(CH₂CH₂CH₃)₂, —N(CH₂CH₂CH₂CH₃)₂, —SH, —SCH₃, —SCH₂CH₃, and —SCH₂CH₂CH₃.

In an embodiment of the present invention, the dye solvent is selected from at least one of CCl₃, CH₃COOCH₃, dimethylformamide (DMF), and dimethyl sulfoxide (DMSO).

In an embodiment of the present invention, the binder resin is at least one selected from the group consisting of a saturated substituted acrylic resin, an unsaturated substituted acrylic resin, and an epoxy group-substituted acrylic acid resin, wherein the saturated substituted acrylic resin includes: acrylic acid, alkyl methacrylate, aryl methacrylate, alkyl aryl methacrylate, or a combination thereof; the unsaturated substituted acrylic resin includes: succinic acid methacrylate; and the epoxy-based acrylic resin includes: epoxy acrylate, epoxy methacrylate, epoxy alkyl methacrylate, epoxy aryl methacrylate, or a combination thereof.

In an embodiment of the present invention, the photoinitiator is selected from at least one of acetophenone, benzoin, diimidazole, and benzophenone, wherein the acetophenone includes α,α-diethoxyacetophenone, 2-hydroxy-2-methyl-1-phenyl-1-propanone (HMPP), 2-methyl-2-morpholine-1-(4-methylphenylthio)propan-1-one, or combinations thereof; the benzoin includes benzoyl, acetophenone, benzoin ether, or combinations thereof; and the diimidazole includes hexaaryl diimidazole.

In an embodiment of the present invention, the photoresist solvent is selected from at least one of an ester solvent and an ether solvent.

In an embodiment of the present invention, the photoresist solvent includes ethylene glycol ethyl ether acetate, diethylene glycol butyl ether acetate, propylene glycol monomethyl ether ester, aiethylene glycol diethyl ether, ethylene glycol dibutyl ether, cyclohexanone, isophorone, or combinations thereof.

In an embodiment of the present invention, the additive is selected from at least one of a silane coupling agent, an antioxidant, an ultraviolet absorber, an antifoaming agent, and a leveling agent.

The present invention provides a color photoresist composition in which a sandwich type phthalocyanine compound is added as a dye, and the dye has high thermal stability and high solubility, and can effectively alleviate light scattering caused by pigment particles in a photoresist due to its high thermal stability and high solubility, thereby improving transmittance and contrast of a color filter.

### BRIEF DESCRIPTION OF DRAWINGS

none.

### DETAILED DESCRIPTION OF PREFERRED EMBODIMENTS

In order to make the above description of the present invention more comprehensible, the preferred embodiments are described below in detail with reference to the accompanying drawings.

Hereinafter, the present invention will be described in further detail with reference to examples. It is to be understood, however, that these examples are for illustrative purposes only and are not intended to limit the scope of the present invention, and the scope of the present invention should be accorded the broadest interpretation so as to encompass all such modifications and similar arrangements.

The present invention provides a color photoresist composition in which a semi-sandwich type phthalocyanine compound is introduced as a dye, which can effectively alleviate light scattering caused by pigment particles in a photoresist due to its high thermal stability and high solubility, thereby improving transmittance and contrast of a color filter.

Accordingly, in accordance with an embodiment of the present invention, the present invention provides a color resist composition, including: based on 100 parts by weight of the color photoresist composition, including: 5-10 parts by weight of a pigment dispersion; 5-8 parts by weight of a binder resin; 5-8 parts by weight of a sandwich type phthalocyanine compound dye; 0.3-0.8 parts by weight of a photoinitiator; 70-85 parts by weight of a photoresist solvent; and 0.1-0.2 parts by weight of an additive.

In an embodiment of the present invention, the sandwich type phthalocyanine compound dye includes a sandwich type phthalocyanine compound and a dye solvent, and the sandwich type phthalocyanine compound has a structure of Formula 1:

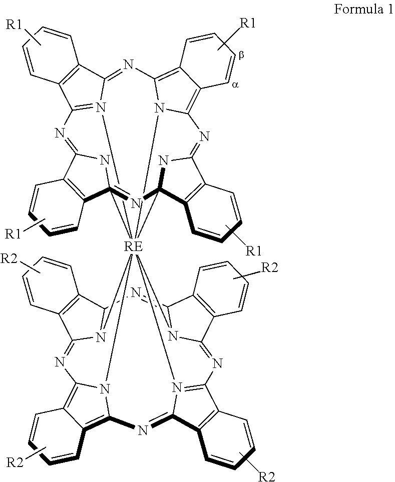

in the Formula 1, a central coordination metal RE is a rare earth metal element;

R1 and R2 are each independently selected from at least one of H, a substituted or unsubstituted C1 to C20 aliphatic carbon chain, a C1 to C20 oxycarbon chain, an aromatic ring, a halogen, a carboxyl group, an ester group, an amino group, and —SH; and

each of substitution positions of R1 and R2 is independently selected from at least one of α and β.

In an embodiment of the present invention, the rare earth metal element includes: lanthanum (La), cerium (Ce), praseodymium (Pr), cerium (Nd), cerium (Pm), cerium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), or scandium (Sc).

Preferably, in an embodiment of the present invention, each of R1 and R2 is independently selected from at least one of H, —C₅H₁₂, —C₆H₁₄, —OC₄H₁₀, —OC₅H₁₂, —OC₆H₁₄, —OC₈H₁₈, a substituted or unsubstituted benzene ring, a substituted or unsubstituted naphthalene ring, a substituted or unsubstituted phenoxy, —F, —Cl, —Br, —I, —COOCH₃, —COOCH₂CH₃, —COOCH₂CH₂CH₃, —NH₂, —N(CH₃)₂, —N(CH₂CH₃)₂, —N(CH₂CH₂CH₃)₂, —N(CH₂CH₂CH₂CH₃)₂, —SH, —SCH₃, —SCH₂CH₃, and —SCH₂CH₂CH₃. R1 and R2 may be selected from a same substituent group at correspondingly the same position, from a same substituent group at different positions, or from different substituent groups at different positions.

The sandwich type phthalocyanine compound has a structure represented by the Formula 1, since the dye monomer is formed by two phthalocyanine groups under a coordination bond action of a rare earth metal of a large radius, the dye monomer has lost planarity of the phthalocyanine. Due to the coordination of the metal, the phthalocyanine groups at both ends exhibit a bowl-like structure, which significantly reduces 7-7 interactions between molecules, and greatly reduces the aggregation between molecules, so that it can have good solubility.

In an embodiment of the present invention, the dye solvent is selected from at least one of CCl₃, CH₃COOCH₃, dimethylformamide (DMF), and dimethyl sulfoxide (dimethyl sulfoxide, DMSO).

In an embodiment of the present invention, the pigment is not particularly limited, and various pigments known in the art can be used. For example, the pigment may include at least one of a green pigment, a blue pigment, and a yellow pigment, wherein the green pigment includes a halogen-substituted copper phthalocyanine pigment; the blue pigment includes a copper phthalocyanine pigment; and the yellow pigment includes an indoline-based pigment, a quinophthalone-based pigment, a nickel composite pigment, or combinations thereof. The above pigments can be blended in different proportions to achieve the desired color.

In an embodiment of the present invention, the binder resin is at least one selected from the group consisting of a saturated substituted acrylic resin, an unsaturated substituted acrylic resin, and an epoxy group-substituted acrylic acid resin. Preferably, the saturated substituted acrylic resin includes: acrylic acid, alkyl methacrylate, aryl methacrylate, alkyl aryl methacrylate, or a combination thereof; the unsaturated substituted acrylic resin includes: succinic acid methacrylate; and the epoxy-based acrylic resin includes: epoxy acrylate, epoxy methacrylate, epoxy alkyl methacrylate, epoxy aryl methacrylate, or a combination thereof.

In an embodiment of the present invention, the photoinitiator is selected from at least one of acetophenone, benzoin, diimidazole, and benzophenone. Preferably, the acetophenone includes α,α-diethoxyacetophenone, 2-hydroxy-2-methyl-1-phenyl-1-propanone (HMPP), 2-methyl-2-morpholine-1-(4-methylphenylthio)propan-1-one, or combinations thereof; the benzoin includes benzoyl, acetophenone, benzoin ether, or combinations thereof; and the diimidazole includes hexaaryl diimidazole.

In an embodiment of the present invention, the photoinitiator is selected from at least one of acetophenone, benzoin, diimidazole, and benzophenone. Preferably, the photoresist solvent includes ethylene glycol ethyl ether acetate, diethylene glycol butyl ether acetate, propylene glycol monomethyl ether ester, aiethylene glycol diethyl ether, ethylene glycol dibutyl ether, cyclohexanone, isophorone, or combinations thereof.

In an embodiment of the present invention, the additive is selected from at least one of a silane coupling agent, an antioxidant, an ultraviolet absorber, an antifoaming agent, and a leveling agent.

According to the above embodiment, the present invention provides a color photoresist composition in which a semi-sandwich type phthalocyanine compound is introduced as a dye, which can effectively alleviate light scattering caused by pigment particles in a photoresist due to its high thermal stability and high solubility, thereby improving transmittance and contrast of a color filter.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A color photoresist composition, based on 100 parts by weight of the color photoresist composition, comprising:
5-10 parts by weight of a pigment dispersion;
5-8 parts by weight of a binder resin;
5-8 parts by weight of a sandwich type phthalocyanine compound dye;
0.3-0.8 parts by weight of a photoinitiator;
70-85 parts by weight of a photoresist solvent; and
0.1-0.2 parts by weight of an additive, wherein
the sandwich type phthalocyanine compound dye comprises a sandwich type phthalocyanine compound and a dye solvent, and the sandwich type phthalocyanine compound has a structure of Formula 1: 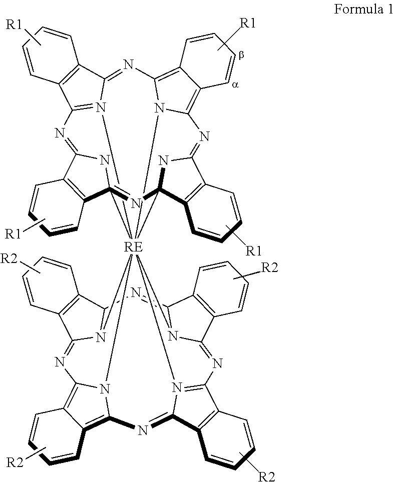
in the Formula 1, a central coordination metal RE is a rare earth metal element;
R1 and R2 are each independently selected from at least one of H, a substituted or unsubstituted C1 to C20 aliphatic carbon chain, a C1 to C20 oxycarbon chain, an aromatic ring, a halogen, a carboxyl group, an ester group, an amino group, and —SH; and
each of substitution positions of R1 and R2 is independently selected from at least one of α and β, and
the rare earth metal element comprises: lanthanum (La), cerium (Ce), praseodymium (Pr), cerium (Nd), cerium (Pm), cerium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), or scandium (Sc).

2. The color photoresist composition according to claim 1, wherein each of R1 and R2 is independently selected from at least one of H, —C₅CH₁₂, —C₆H₁₄, —OC₄H₁₀, —OC₅H₁₂, —OC₆H₁₄, —OC₈H₁₈, a substituted or unsubstituted benzene ring, a substituted or unsubstituted naphthalene ring, a substituted or unsubstituted phenoxy, —F, —Cl, —Br, —I, —COOCH₃, —COOCH₂CH₃, —COOCH₂CH₂CH₃, —NH₂, —N(CH₃)₂, —N(CH₂CH₃)₂, —N(CH₂CH₂CH₃)₂, —N(CH₂CH₂CH₂CH₃)₂, —SH, —SCH₃, —SCH₂CH₃, and —S CH₂CH₂CH₃.

3. The color photoresist composition according to claim 1, wherein the dye solvent is selected from at least one of CCl₃, CH₃COOCH₃, dimethylformamide (DMF), and dimethyl sulfoxide (DMSO).

4. The color photoresist composition according to claim 1, wherein the binder resin is at least one selected from the group consisting of a saturated substituted acrylic resin, an unsaturated substituted acrylic resin, and an epoxy group-substituted acrylic acid resin, wherein
the saturated substituted acrylic resin comprises: acrylic acid, alkyl methacrylate, aryl methacrylate, alkyl aryl methacrylate, or a combination thereof;
the unsaturated substituted acrylic resin comprises: succinic acid methacrylate; and
the epoxy-based acrylic resin comprises: epoxy acrylate, epoxy methacrylate, epoxy alkyl methacrylate, epoxy aryl methacrylate, or a combination thereof.

5. The color photoresist composition according to claim 1, wherein the photoinitiator is selected from at least one of acetophenone, benzoin, diimidazole, and benzophenone, wherein
the acetophenone comprises α,α-diethoxyacetophenone, 2-hydroxy-2-methyl-1-phenyl-1-propanone (HMPP), 2-methyl-2-morpholine-1-(4-methylphenylthio)propan-1-one, or combinations thereof;
the benzoin comprises benzoyl, acetophenone, benzoin ether, or combinations thereof; and
the diimidazole comprises hexaaryl diimidazole.

6. The color photoresist composition according to claim 1, wherein the photoresist solvent is selected from at least one of an ester solvent and an ether solvent.

7. The color photoresist composition according to claim 1, wherein the photoresist solvent comprises ethylene glycol ethyl ether acetate, diethylene glycol butyl ether acetate, propylene glycol monomethyl ether ester, or combinations thereof.

8. The color photoresist composition according to claim 1, wherein the additive is selected from at least one of a silane coupling agent, an antioxidant, an ultraviolet absorber, an antifoaming agent, and a leveling agent.

9. A color photoresist composition, based on 100 parts by weight of the color photoresist composition, comprising:
5-10 parts by weight of a pigment dispersion;
5-8 parts by weight of a binder resin;
5-8 parts by weight of a sandwich type phthalocyanine compound dye;
0.3-0.8 parts by weight of a photoinitiator;
70-85 parts by weight of a photoresist solvent; and
0.1-0.2 parts by weight of an additive.

10. The color photoresist composition according to claim 9, wherein the sandwich type phthalocyanine compound dye comprises a sandwich type phthalocyanine compound and a dye solvent, and the sandwich type phthalocyanine compound has a structure of Formula 1: 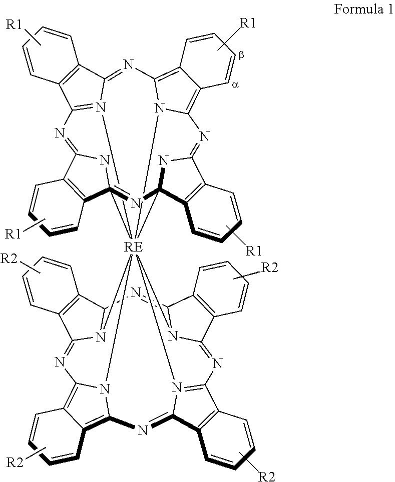
in the Formula 1, a central coordination metal RE is a rare earth metal element;
each of R1 and R2 is independently selected from at least one of H, a substituted or unsubstituted C1 to C20 aliphatic carbon chain, a C1 to C20 oxycarbon chain, an aromatic ring, a halogen, a carboxyl group, an ester group, an amino group, and —SH; and
each of substitution positions of R1 and R2 is independently selected from at least one of α and β.

11. The color photoresist composition according to claim 10, wherein the rare earth metal element comprises: lanthanum (La), cerium (Ce), praseodymium (Pr), cerium (Nd), cerium (Pm), cerium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), or scandium (Sc).

12. The color photoresist composition according to claim 10, wherein R1 and R2 are each independently selected from at least one of H, —C₅H₁₂, —C₆H₁₄, —OC₄H₁₀, —OC₅H₁₂, —OC₆H₁₄, —OC₈H₁₈, a substituted or unsubstituted benzene ring, a substituted or unsubstituted naphthalene ring, a substituted or unsubstituted phenoxy, —F, —Cl, —Br, —I, —COOCH₃, —COOCH₂CH₃, —COOCH₂CH₂CH₃, —NH₂, —N(CH₃)₂, —N(CH₂CH₃)₂, —N(CH₂CH₂CH₃)₂, —N(CH₂CH₂CH₂CH₃)₂, —SH, —SCH₃, —SCH₂CH₃, and —S CH₂CH₂CH₃.

13. The color photoresist composition according to claim 10, wherein the dye solvent is selected from at least one of CCl₃, CH₃COOCH₃, dimethylformamide (DMF), and dimethyl sulfoxide (DMSO).

14. The color photoresist composition according to claim 9, wherein the binder resin is at least one selected from the group consisting of a saturated substituted acrylic resin, an unsaturated substituted acrylic resin, and an epoxy group-substituted acrylic acid resin, wherein
the saturated substituted acrylic resin comprises: acrylic acid, alkyl methacrylate, epoxy alkyl methacrylate, epoxy aryl methacrylate, or a combination thereof;
the unsaturated substituted acrylic resin comprises: succinic acid methacrylate; and
the epoxy-based acrylic resin comprises: epoxy acrylate, epoxy methacrylate, epoxy alkyl methacrylate, epoxy aryl methacrylate, or a combination thereof.

15. The color photoresist composition according to claim 9, wherein the photoinitiator is selected from at least one of acetophenone, benzoin, diimidazole, and benzophenone, wherein
the acetophenone comprises α,α-diethoxyacetophenone, 2-hydroxy-2-methyl-1-phenyl-1-propanone (HMPP), 2-methyl-2-morpholine-1-(4-methylphenylthio)propan-1-one, or combinations thereof;
the benzoin comprises benzoyl, acetophenone, benzoin ether, and combinations thereof; and
the diimidazole comprises hexaaryl diimidazole.

16. The color photoresist composition according to claim 9, wherein the photoresist solvent is selected from at least one of an ester solvent and an ether solvent.

17. The color photoresist composition according to claim 9, wherein the photoresist solvent comprises ethylene glycol ethyl ether acetate, diethylene glycol butyl ether acetate, propylene glycol monomethyl ether ester, or combinations thereof.

18. The color photoresist composition according to claim 9, wherein the additive is selected from at least one of a silane coupling agent, an antioxidant, an ultraviolet absorber, an antifoaming agent, and a leveling agent.
